(19) United States
(12) Patent Application Publication
(10) Pub. No.: US 2004/0189895 A1
(43) Pub. Date: Sep. 30, 2004

(54) [COLOR FILTER AND METHOD FOR FABRICATING THE SAME]

(76) Inventors: Chieh-Po Chen, Taipei (TW); Jui-Lung Hung, Taoyuan (TW); Chi-Hsien Sung, Taoyuan (TW); Nai-Yi Fan, Taipei (TW); Ming-Pang Liu, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,571

(22) Filed: Jul. 31, 2003

(30) Foreign Application Priority Data
Mar. 28, 2003 (TW) 92107060

(51) Int. Cl. G02F 1/1335

(52) U.S. Cl. 349/106

(57) ABSTRACT

A color filter having a substrate, a black matrix and a plurality of color layers is provided. The black matrix having a plurality of lattices is located on the substrate. The color layers are located within the lattices respectively. The width a of the overlapped area of the color layers and the black matrix is 0-6.0 microns, the thickness b of the overlapped area of the color layers and the black matrix is 0-1.0 microns. In addition, the thickness c of the color mesas is equal to or larger than the thickness d of the black matrix. The color filter is fabricated without performing polishing process.

### CROSS REFERENCE TO RELATED APPLICATIONS

This application claims the priority benefit of Taiwan application serial no. 92107060, filed Mar. 28, 2003.

### BACKGROUND OF INVENTION

1. Field of Invention

The present invention relates to the structure of a color filter (CF) and the fabrication method. More particularly, the present invention relates to a structure of color filter capable of improving the phenomenon of color non-uniform at the edge frame, called edge mura, and the fabrication method.

2. Description of Related Art

For the fast and great development on the multi-media world, it is resulted from the fast and great development on the semiconductor fabrication technologies or the displaying devices. With respect to the displaying devices, the cathode ray tube (CRT) has its good displaying quality and economic advantages and has occupied most of the market in displaying devices. However, from the point of view about the environment with desk terminal as the displaying device used by person, or the environment protection, under the trend of considering the energy consumption, it can be seen that the CRT still has several issues due to the occupied space and energy consumption. It has no efficient solution on the requirements of light, thin, small, and low power consumption. Instead, the thin film transistor (TFT) liquid crystal display (LCD) with advantages of high displaying quality, high using efficiency on space, low power consumption, no radiation and so on, has gradually become the trend in the market.

Currently, the LCD is developed on the direction, having full color, large displaying size, high resolution, and low cost. The LCD needs a color filter to achieve the colorful displaying effect. The color filter is usually implemented on a transparent glass substrate. The transparent substrate is implemented with a black matrix (BM) for shielding the light as well as red film layer, green film later and blue film layer with respect to the arrangement of pixels. The structure of color filter is described as follows: FIG. 1 is a cross-sectional view, schematically illustrating the conventional color filter. In FIG. 1, the conventional filter 100 includes a substrate 102, a BM 104, multiple color film layers 108, a planar layer 110, and a common electrode 112. The BM is disposed on a surface 102a of the substrate 102, and the BM 104 has several grid regions 106 for exposing the surface 102a of the substrate 102. The color film layer 108 (red, green, blue) is disposed over the grid region 106. It should be noted that the planar layer 110 is disposed over the color film layer 108 and the BM 104, and the common electrode 112 is disposed on the planar surface of the planar layer 110.

FIG. 2 is a fabrication process diagram, schematically illustrating the conventional method to fabricate the color filter. In FIG. 1 and FIG. 2, the conventional color filter 100 is fabricated by the processes, including first providing a substrate 102 in step S120. The substrate 102 usually is the glass substrate, plastic substrate, acrylic substrate, or other transparent substrate. Then, a color film layer 108 and a BM 104 are formed on the substrate 102. In step S130, a width a of the overlapping region between the color film layer 108 and the BM layer 104 is controlled to be greater than 10 microns. And, the overlapping portion of the color film layer 108 with the BM 104 has a thickness B, controlled to be between 1.2 microns and 1.6 microns.

In FIG. 1 and FIG. 2, according to the foregoing design rule, it is occurred often that the thickness of the color film layer 108 at the overlapping region is over thick. This causes the spacer, which is disposed in liquid crystal (LC) cell to have the cell gap, to stand on the overlapping region between the color film layer 108 and the BM 104, and then causes the cell gap of the LC cell to be not uniform. This results in that the phenomenon of edge mura for the LCD with non-uniform color at the frame edge. In step S140, a planar layer 110 in the conventional method is formed over the color film layer 108 and the BM 104. In step S150, a common electrode 112 is formed on the planar layer 110, so as to prevent the edge mura phenomenon from occurring.

In the conventional structure of color filter, the planar layer is necessary to be used to solve the issue of edge mura. However, the formation of the planar layer cause the fabrication cost not to be further reduced.

### SUMMARY OF INVENTION

The invention provides a structure of color filter, of which the edge mura phenomenon can be effectively reduced.

The invention provides a method for fabricating a color filter, of which the edge mura phenomenon can be effectively reduced.

As embodied and broadly described herein, the invention provides a structure of color filter, including a substrate, a BM and multiple color film layers. Wherein, the BM is disposed over the substrate. The BM has several grid regions, exposing the substrate. The color film layers are respectively disposed within the grid regions of the BM. A width a of the overlapping region between the color film layer and the BM is about 0-6.0 microns. A thickness b of the color film layer at the overlapping region is about 0-1.0 microns. In addition, the color film layer has the thickness c, which is greater than or equal to a thickness d of the BM, for example.

In the preferred embodiment of the invention, the substrate includes, for example, glass substrate, plastic substrate, acrylic substrate, or other transparent substrate.

In the invention, the BM includes, for example, shielding resin or Cr metal, and so on for shielding light.

In the invention, the color film layer includes, for example, red film layer, green film layer, and blue film layer. These red, green, and blue layers have been arranged to be, for example, mosaic type, stripe type, four pixel type, and triangle type.

In the color filter of the invention, it further includes a common electrode, directly being formed on the BM an the color film layer. Also and, materials of the common electrode includes indium tin oxide (ITO), indium zinc oxide (IZC), and so on.

The invention also provides a method to fabricate the color filter, including steps of (a) providing a substrate. (b) a BM and multiple color film layers are formed over the substrate. Wherein, a width a of the overlapping region between the color film layer and the BM, and a thickness b of the color film layer at the overlapping region are controlled to have a=0-6.0 microns, and b=0-1.0 microns. (c) a common electrode is directly formed over the BM and the color film layers.

The invention also provides a method for fabricating the color filter, including steps of (a). In step (b), a BM and multiple color film layers are formed over the substrate. Wherein, a width a of the overlapping region between the color film layer and the BM, a thickness b of the color film layer at the overlapping region with the BM, a thickness c of the color film layer, and a thickness d of BM are controlled to have a=0-6.0 microns, b=0-1.0 microns, and c≧d. In step (c), a common electrode is formed on the BM and the color film layer.

In the invention, since the width and the thickness for the overlapping portion of the color film layer with the BM are controlled within a proper range, wherein the width is 0-6.0 microns and the thickness is 0-1.0 microns, so that it can be effectively prevented from occurring for the edge mura phenomenon caused by an over thickness difference of the coating layer.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view, schematically illustrating the conventional color filter.

FIG. 2 is a fabrication process diagram, schematically illustrating the conventional method to fabricate the color filter.

FIG. 3 is a cross-sectional view, schematically illustrating the color filter, according to a preferred embodiment of the invention.

FIG. 4 is a fabrication process diagram, schematically illustrating the method to fabricate the color filter, according to the preferred embodiment of the invention.

FIG. 5 is a cross-sectional view, schematically illustrating the color filter, according to another preferred embodiment of the invention.

### DETAILED DESCRIPTION

FIG. 3 is a cross-sectional view, schematically illustrating the color filter, according to a preferred embodiment of the invention. In FIG. 3, the color filter 300 includes a substrate 202, a BM 204, multiple color film layers 208 and a common electrode 210. Wherein, the BM 204 is disposed on the surface 202a of the substrate 202, and has several grid regions 206 to expose the surface 202a of the substrate 202. The color film layers 208 (red, green, and blue) are disposed within the grid regions 206 of the BM 204. It should be noted that the color filter of the invention need no the planar layer for planarization. The common electrode 210 is directly disposed over the BM 204 and the color film layers 208.

Also referring to FIG. 3, the substrate 202 includes, for example, glass substrate, plastic substrate, acrylic substrate, or other transparent substrate. The BM includes, for example, acrylic acid material as the light shielding resin or Cr metal as the light shielding metal. The color film layer 208 includes, for example, red film layer, green film layer, and blue film layer. These red, green, and blue layers have been arranged to be, for example, mosaic type, stripe type, four pixel type, and triangle type. In addition, the common electrode of the embodiment includes indium tin oxide (ITO), indium zinc oxide (IZC), or the transparent conductive material.

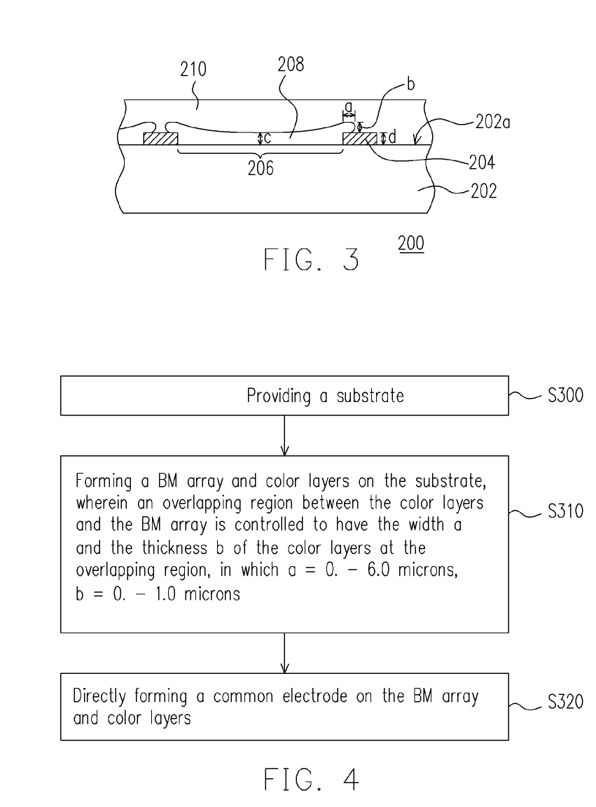

FIG. 4 is a fabrication process diagram, schematically illustrating the method to fabricate the color filter, according to the preferred embodiment of the invention. In FIG. 3 and FIG. 4, the method for fabricating the color filter 200 includes, first, providing a substrate 202, in step S300. In step S310, the color film layer 208 and the BM 204 are formed over the substrate 202. Wherein, a width a of the overlapping region between the color film layer 208 and the BM 204 is controlled to be 0 6.0 microns, and a thickness b of the color film layer 208 at the overlapping region with the BM 204 is controlled to 0 1.0 microns.

Still referring to FIG. 3 and FIG. 4, the width a of the overlapping region is controlled to be between 0 micron and 6.0 microns, and the thickness b is controlled to be between 0 micron and 1.0 micron. Therefore, the overlapping region between the color film layer 208 and the BM 204 is not over large, and therefore, it is not occurred for the issue about non-uniform of cell gap, causing the edge mura. According to the foregoing descriptions, the overlapping region of all of the coating layers (color film layer 208s and BM 204) has no the issue about overlarge thickness, so that the common electrode 210 can be directly formed on the color film layer 208 and the BM 204 (step S320). Then, color filter 200 can be formed.

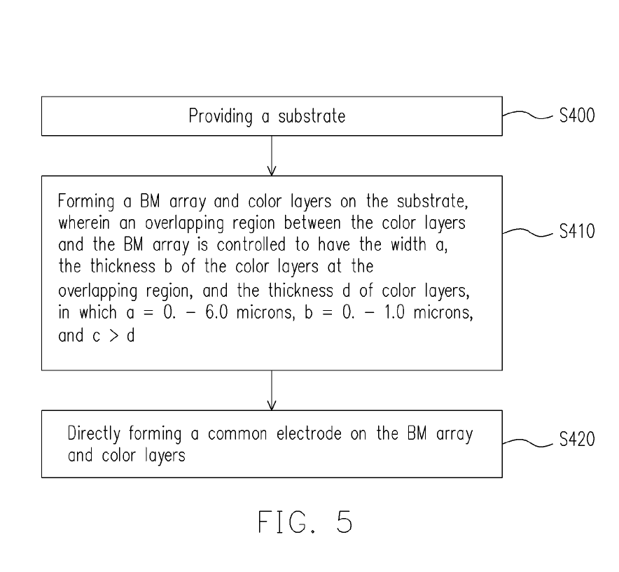

FIG. 5 is a cross-sectional view, schematically illustrating the color filter, according to another preferred embodiment of the invention. Referring to FIGS. 3-5, the fabrication process is similar to the process in FIG. 4. The difference is as follows. In addition to the condition of the width a of the overlapping region between the color film layer and the BM and the thickness b of the color film layer at the overlapping region with the BM, a thickness c of the color film layer 208 is further controlled to be greater than or equal to a thickness d of the BM 204.

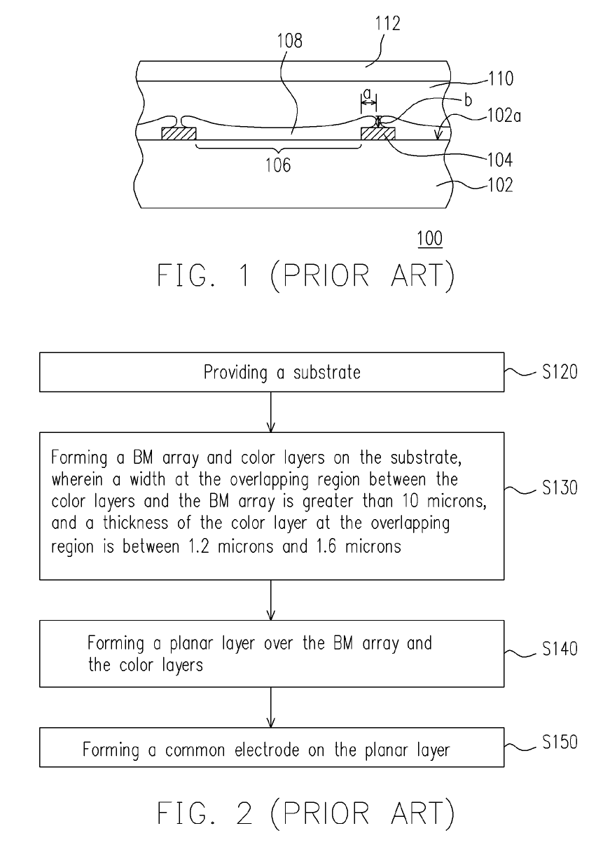

Referring to table 1, a comparison of some parameters between the TFT-LCD of the invention and the conventional TFT-LCD is made, based on 140 sample points. Wherein, the conventional TFT-LCD is based on the structure of color filter shown in FIG. 1, and the TFT-LCD of the invention is based on the structure of color filter shown in FIG. 3.

TABLE 1

| | Convention | Invention |
|---|---|---|
| Difference of cell gap | 0.593 microns | 0.241 microns |
| (R = dmax − dmin) | | |
| Standard Deviation (SD) | 0.126 | 0.050 |
| Sampling points | 140 | 140 |
| CV (SD/Average) | 2.61 | 1.165 |

In table 1, the planarity on the cell gap of the color filer in the invention is improved a lot at a good condition. The difference of cell gap (R=dmax−dmin), the Standard Deviation (SD), and CV quantity for each sampling point is smaller than the conventional results. According to the data for each aspect, it indicates that the uniformity of thickness of the color filter is better than the conventional technology.

In summary, the color filter structure of the invention and the fabrication process at least has the following advantages.

1. In the invention, the width and the thickness of the overlapping region between the color film and the BM are controlled to be within a proper range, in which width is 0 6.0 microns and thickness is 0 1.0 micron. As a result, the phenomenon of edge mura due to the overlarge difference of thickness for the coating layers can be effectively reduced.

2. In the invention, the width and the thickness of the overlapping region between the color film and the BM are controlled to be within a proper range, in which width is 0 6.0 microns and thickness is 0 1.0 micron. Also and, the thickness of the color film is greater than or equal to the thickness of the BM. As a result, the phenomenon of edge mura due to the overlarge difference of thickness for the coating layers can be effectively reduced.

3. The invention need no the formation of the planar layer over the color film layer and the BM, but the planarity remains. As a result, the fabrication process of color filter is simplified.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A structure of color filter, comprising:
a substrate;
a black matrix (BM), disposed over the substrate, wherein the BM includes grid regions exposing the substrate; and
a plurality of color film layers, disposed within the grid regions, wherein a width a of an overlapping region between the color film layers and the BM is 0 6.0 microns, and a thickness b of the color film layers at the overlapping region is 0 1.0 microns.

2. The structure of claim 1, wherein a thickness of the color film layers is c, and a thickness of the BM is d, wherein c is greater than or equal to d.

3. The structure of claim 1, wherein the substrate is a transparent substrate.

4. The structure of claim 1, wherein the BM includes light shielding resin.

5. The structure of claim 1, wherein the BM includes Cr metal.

6. The structure of claim 1, wherein color film layers comprises red film layers, green film layers, and blue film layers.

7. The structure of claim 6, wherein the red film layers, the green film layers, and the blue film layers are arranged into a type selected from the group consisting of mosaic type, stripe type, four pixel type, and triangle type.

8. The structure of claim 1, further comprising a common electrode, directly disposed on the BM and the color film layers.

9. The structure of claim 1, wherein the common electrode includes indium tin oxide or indium zinc oxide.

10. A method for fabricating a color filter, comprising:
providing a substrate;
forming a black matrix (BM) and color film layers over the substrate, wherein a width a of an overlapping region between the color film layers and the BM, and a thickness b of the color film layers at the overlapping region are controlled to have a=0-6.0 microns, and b=0-1.0 microns; and
forming a common electrode directly over the BM and the color film layers.

11. A method for fabricating a color filter, comprising:
providing a substrate;
forming a black matrix (BM) and color film layers over the substrate, wherein a width a of an overlapping region between the color film layers and the BM, a thickness b of the color film layers at the overlapping region, a thickness c of the color film layers, and a thickness d of the BM are controlled to have a=0-6.0 microns and b=0-1.0 microns, c≧d; and
forming a common electrode directly over the BM and the color film layers.
